(19) United States
(12) Patent Application Publication
(10) Pub. No.: US 2024/0265068 A1
(43) Pub. Date: Aug. 8, 2024

(54) METHOD AND SYSTEM FOR DIGITAL RIGHT MANAGEMENT (DRM) OF DATA OBTAINED FROM CONENCTED CARS

(71) Applicant: OTONOMO TECHNOLOGIES LTD., Herzeliya Pituach (IL)

(72) Inventor: Yosef Haim ITZKOVICH, Raanana (IL)

(73) Assignee: OTONOMO TECHNOLOGIES LTD., Herzeliya Pituach (IL)

(21) Appl. No.: 18/164,702

(22) Filed: Feb. 6, 2023

(51) Int. Cl. G06F 21/10; G06F 21/62

(52) U.S. Cl. CPC G06F 21/105; G06F 21/6209

(57) ABSTRACT

A method and a system for establishing and applying a digital right management (DRM) of data relating to connected cars and obtained from a plurality of sources are provided herein. The method may include the following steps: obtaining a plurality of data entries relating to connected cars and obtained directly from the connected cars; analyzing a plurality of use cases applicable for each of the obtained data entries; automatically selecting, from a plurality of DRM policies, a most suitable DRM policy for the determined use cases; executing the DRM policy of said data entry, using a computer processor. wherein the execution of the DRM Policy on the data entry includes: owner-guardian contractual relationship; permissions, and data section.

### FIELD OF THE INVENTION

The present invention relates generally to the field of data processing, and more particularly to data processing affiliated with connected cars.

### BACKGROUND OF THE INVENTION

Prior to setting forth the background of the invention, it may be helpful to set forth definitions of certain terms that will be used hereinafter.

The term “connected car” as used herein is defined as a car (or any other vehicle such as an aerial vehicle) that is equipped with any form of wireless network connectivity access, and usually also with a wireless local area network. This allows the car to share internet access with other devices both inside as well as outside the vehicle. Often, the car is also outfitted with special technologies that tap into the internet or wireless LAN and provide additional benefits to the driver.

The term “connected car application” as used herein is defined as software application that are supported by data and/or networks related to connected car. Connected cars applications can be separated into two categories: single vehicle applications: In-car content and service applications implemented by a single vehicle in connection with a cloud or back office; and cooperative safety and efficiency applications.

Connected car application provide connectivity between vehicles (or infrastructure) directly and would be utilized and operate better if it complies cross-brand and cross-borders as it may require standards and regulation. Some may be convenience applications, others safety, which may require regulation.

The term “data marketplace” or “data market” as used herein is defined an online platform that enables a plurality of users (subscribers) to access and consume data. Data marketplaces typically offer various types of data for different markets and from different sources. Common types of data consume include business intelligence, demographics, research and market data. Data types can be mixed and structured in a variety of ways. Data vendors may offer data in specific formats for individual clients.

Data consumed in these marketplaces may be used by businesses of all kinds, fleets, business and safety applications and many types of analysts. Data marketplaces have proliferated with the growth of big data, as the amount of data collected by municipalities and smart cities, businesses, websites and services has increased, and all that data has become increasingly recognized as an asset.

The term “data anonymization” as used herein is defined as type of information sanitization whose intent is privacy protection. It is the process of either encrypting or removing personally identifiable information from data sets, so that the people whom the data describe remain anonymous.

One major challenge for managing the date related to connected cars is that the data flowing from various sources comes does not have any right management mechanism and can be used without limitation by data consumers.

### SUMMARY OF THE INVENTION

According to some embodiments of the present invention, a method and a system for establishing and applying a digital right management of data relating to connected cars and obtained from a plurality of sources are provided herein. The method may include the following steps: obtaining a plurality of data entries relating to connected cars and obtained directly from the connected cars; analyzing a plurality of use cases applicable for each of the obtained data entries; automatically selecting, from a plurality of DRM policies, a most suitable DRM policy for the determined use cases; executing the DRM policy of said data entry, using a computer processor. The execution of the DRM policy on the data entry may include owner-guardian contractual relationship; permissions, and data section.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a block diagram illustrating non-limiting exemplary architecture of a marketplace server for managing data relating to connected-cars in accordance with embodiments of the present invention; and

FIG. 2 is a high-level flowchart illustrating non-limiting exemplary method in accordance with embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well known features may be omitted or simplified in order not to obscure the present invention.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

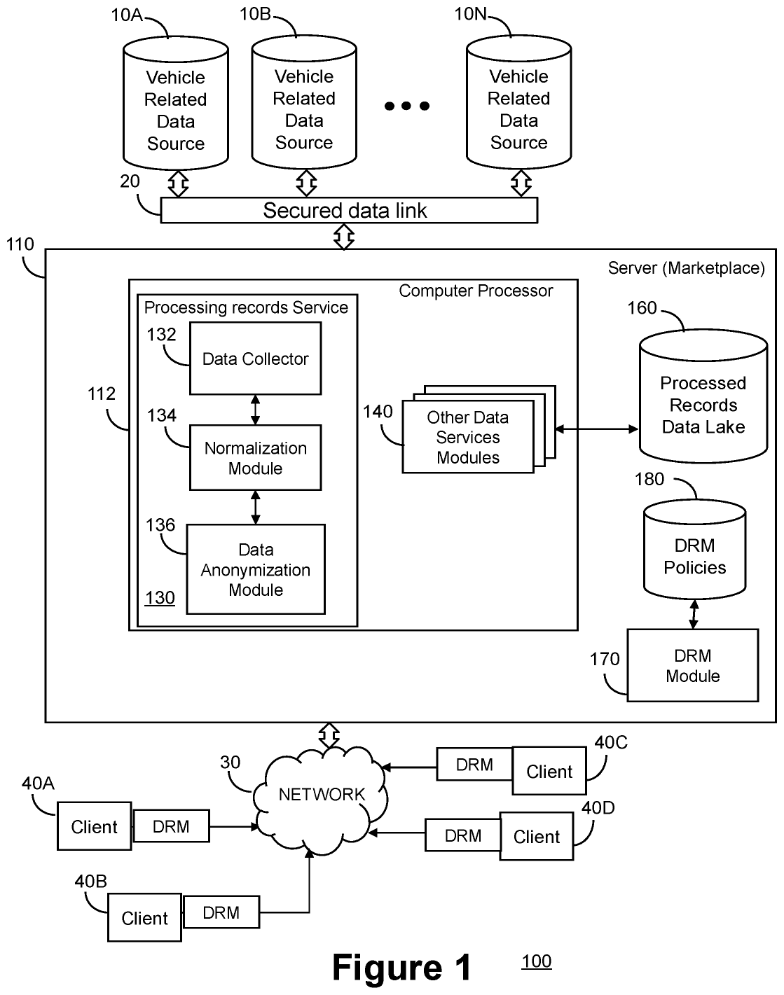

FIG. 1 is a block diagram illustrating non-limiting exemplary architecture of a marketplace server 110 for managing data relating to connected-cars in accordance with embodiments of the present invention. The system may include: a server 110 configured to obtain a plurality of automotive data relating to connected vehicles originated from a plurality of data sources 11A-10N. System 100 may include a server 110 implementing the data marketplace and connected via network 30 to a plurality of users 40A-50C (e.g., drivers who are the data owners) each associated with a digital right management (DRM) mechanism which is controlled by DRM module 170 on serve 110. Vehicle related data, possibly obtained from various sensors on the connected vehicles of users 40A-40C, may be stored in raw format on a plurality of raw automotive data sources 10A-10N and may be accessed by server 110 via a secured data link 20. Server 110 may include a records processing module 160 implemented by a computer readable code running on computer processor 112. Records processing module 130 may include a data collector 132, a normalization module 134 and a data anonymization module 136 that are configured to collect, normalize and anonymize respectively the data arriving from the plurality of automotive data sources 10A-10N, thus creating a processed records data lake 160 storing vehicle related data.

Server 110 may include other data services modules 140 which are consumed upon request by clients 40A-40D and subject to the enforcing of the DRM policies as explained below.

In accordance with some embodiments of the present invention, server 110 may be configured for establishing and applying digital right management of data relating to connected cars and obtained from a plurality of sources. In operation, server 110 may be configured to: obtain a plurality of data entries relating to connected cars and obtained directly from the connected cars; analyze a plurality of use cases applicable for each of the obtained data entries; automatically select, from a plurality of DRM policies 180, a most suitable DRM policy for the determined use cases; and instruct a plurality of DRM-enabled clients 40A-40D associated with data consumers and connected to said server via a network and configured to execute the selected DRM policy of said data entry using DRM module 170 which may selectively limit the use of automotive data based on DRM policies.

According to some embodiments of the present invention, the execution of the DRM policy on the data entry may comprise: owner-guardian contractual relationship; permissions, and data section.

According to some embodiments of the present invention, the permission includes at least one of: full permission, ability to change data ownership, ability to forward to a guardian, ability to limit times of forwarding to guardian.

According to some embodiments of the present invention, the use cases refer to use cases of consuming the data.

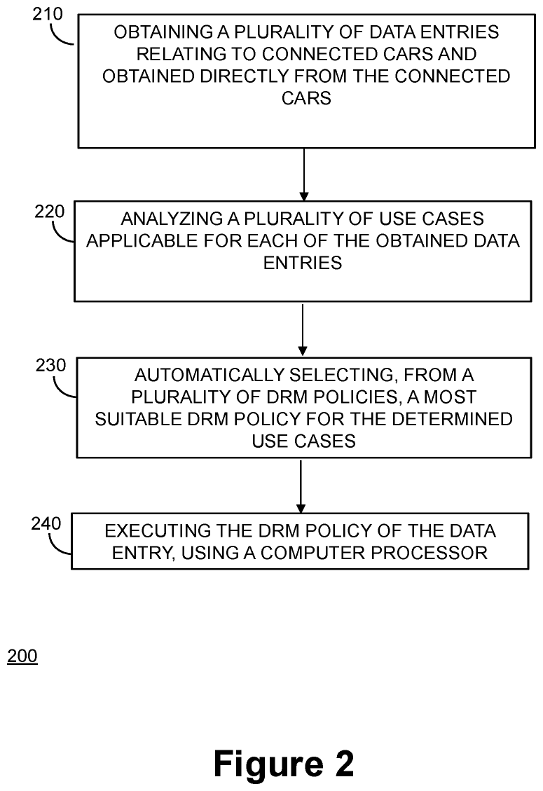

FIG. 2 is a high-level flowchart illustrating non-limiting exemplary method in accordance with embodiments of the present invention. The method may include: obtaining a plurality of data entries relating to connected cars and obtained directly from the connected cars 210; analyzing a plurality of use cases applicable for each of the obtained data entries 220; automatically selecting, from a plurality of DRM policies, a most suitable DRM policy for the determined use cases 230; and executing the DRM policy of said data entry, using a computer processor 240.

It should be noted that the method according to embodiments of the present invention may be stored as instructions in a computer readable medium to cause processors, such as central processing units (CPU) to perform the method. Additionally, the method described in the present disclosure can be stored as instructions in a non-transitory computer readable medium, such as storage devices which may include hard disk drives, solid state drives, flash memories, and the like. Additionally, non-transitory computer readable medium can be memory units.

In order to implement the method according to embodiments of the present invention, a computer processor may receive instructions and data from a read-only memory or a random-access memory or both. At least one of aforementioned steps is performed by at least one processor associated with a computer. The essential elements of a computer are a processor for executing instructions and one or more memories for storing instructions and data. Generally, a computer will also include, or be operatively coupled to communicate with, one or more mass storage devices for storing data files. Storage modules suitable for tangibly embodying computer program instructions and data include all forms of non-volatile memory, including by way of example semiconductor memory devices, such as EPROM, EEPROM, and flash memory devices and also magneto-optic storage devices.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Program code embodied on a computer readable medium may be transmitted using any appropriate medium, including but not limited to wireless, wire-line, optical fiber cable, RF, etc., or any suitable combination of the foregoing.

Computer program code for carrying out operations for aspects of the present invention may be written in any combination of one or more programming languages, including an object oriented programming language such as Java, Smalltalk, JavaScript Object Notation (JSON), C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or portion diagrams of methods, apparatus (systems) and computer program products according to embodiments of the invention. It will be understood that each portion of the flowchart illustrations and/or portion diagrams, and combinations of portions in the flowchart illustrations and/or portion diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or portion diagram portion or portions.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or portion diagram portion or portions.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or portion diagram portion or portions.

The aforementioned flowchart and diagrams illustrate the architecture, functionality, and operation of possible implementations of systems, methods and computer program products according to various embodiments of the present invention. In this regard, each portion in the flowchart or portion diagrams may represent a module, segment, or portion of code, which comprises one or more executable instructions for implementing the specified logical function(s). It should also be noted that, in some alternative implementations, the functions noted in the portion may occur out of the order noted in the figures. For example, two portions shown in succession may, in fact, be executed substantially concurrently, or the portions may sometimes be executed in the reverse order, depending upon the functionality involved. It will also be noted that each portion of the portion diagrams and/or flowchart illustration, and combinations of portions in the portion diagrams and/or flowchart illustration, can be implemented by special purpose hardware-based systems that perform the specified functions or acts, or combinations of special purpose hardware and computer instructions.

In the above description, an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is to be understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention may be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

1. A method of establishing and applying digital right management (DRM) of data relating to connected cars and obtained from a plurality of sources, the method comprising:
obtaining a plurality of data entries relating to connected cars and obtained directly from the connected cars;
analyzing a plurality of use cases applicable for each of the obtained data entries;
automatically selecting, from a plurality of DRM policies, a most suitable DRM policy for the determined use cases; and
executing the DRM policy of said data entry, using a computer processor.

2. The method according to claim 1, wherein the execution of the DRM policy on the data entry comprises: owner-guardian contractual relationship; permissions, and data section.

3. The method according to claim 1, wherein the permission includes at least one of: full permission, ability to change data ownership, ability to forward to a guardian, ability to limit times of forwarding to guardian.

4. The method according to claim 1, wherein the use cases refer to use cases of consuming the data.

5. A system for establishing and applying digital right management (DRM) of data relating to connected cars and obtained from a plurality of sources, the method comprising:
server configured to:
obtain a plurality of data entries relating to connected cars and obtained directly from the connected cars;
analyze a plurality of use cases applicable for each of the obtained data entries;
automatically select, from a plurality of DRM policies, a most suitable DRM policy for the determined use cases; and
a plurality of DRM client associated with data consumers and connected to said server via a network and configured to execute the selected DRM policy of said data entry.

6. The system according to claim 5, wherein the execution of the DRM policy on the data entry comprises: owner-guardian contractual relationship; permissions, and data section.

7. The system according to claim 5, wherein the permission includes at least one of: full permission, ability to change data ownership, ability to forward to a guardian, ability to limit times of forwarding to guardian.

8. The system according to claim 5, wherein the use cases refer to use cases of consuming the data.

9. A non-transitory computer readable medium for establishing and applying digital right management (DRM) of data relating to connected cars and obtained from a plurality of sources, the computer readable medium comprising a set of instructions that, when executed, cause at least one computer processor to:
obtain a plurality of data entries relating to connected cars and obtained directly from the connected cars;
analyze a plurality of use cases applicable for each of the obtained data entries;
automatically select, from a plurality of DRM policies, a most suitable DRM policy for the determined use cases; and
execute the DRM policy of said data entry.

10. The non-transitory computer readable medium according to claim 9, wherein the execution of the DRM policy on the data entry comprises: owner-guardian contractual relationship; permissions, and data section.

11. The non-transitory computer readable medium according to claim 9, wherein the permission includes at least one of: full permission, ability to change data ownership, ability to forward to a guardian, ability to limit times of forwarding to guardian.

12. The non-transitory computer readable medium according to claim 9, wherein the use cases refer to use cases of consuming the data.
